(19) United States
(12) Patent Application Publication
(10) Pub. No.: US 2013/0112929 A1
(43) Pub. Date: May 9, 2013

(54) CHAIN LOAD BINDER

(71) Applicant: Zhaoyin Xiao, Zhejiang Province (CN)

(72) Inventor: Zhaoyin Xiao, Zhejiang Province (CN)

(21) Appl. No.: 13/295,051

(22) Filed: Nov. 12, 2011

(30) Foreign Application Priority Data
May 3, 2011 (CN) 201110112148.0

(51) Int. Cl. B60P 7/08

(52) U.S. Cl. CPC B60P 7/083
USPC 254/237

(57) ABSTRACT

The present invention discloses a chain load binder in the field of mechanics, which addresses the problem existing in conventional load binders for which larger goods could not be reliably bound by ropes such as ribbons. The chain load binder of the present invention comprises a body, a handle, a tooth stop plate, a catch, a chain and a rotation shaft. The body is linked with a first hook. A spring is provided between the tooth stop plate and the body, which tends to press the tooth stop plate against the ratchet wheel. A positioning member is further provided at the body. The two ends of the spring can act against the positioning member and the tooth stop plate respectively. The positioning member is separate from the body, so that both the body and the positioning member can be easily processed.

### BACKGROUND OF THE INVENTION

1. Field of Invention

The present invention relates to a load binder for binding goods, particularly to a chain load binder, in the field of mechanics.

2. Related Art

When the goods are transported on automobiles, trains or ships, the goods have to be bound to prevent the goods being damaged or lost thanks to jolt, shock or bump during transportation. The load binder is widely used for binding the goods during the transportation. Generally speaking, the goods are bound by using the ribbons, and then the ribbons are tightened by the load binder to bind the goods firmly.

The conventional load binders include a body, a handle, ribbons and two hooks. The hooks could be disposed on the ribbons. The body is provided with a unidirectional rotation mechanism. When the goods are to be bound, said two hooks are hung at both sides of the goods respectively. The handle of the load binder is turned to and fro to tighten the ribbons, aiming at binding the goods closely. However, the goods with large volume and mass would tend to slip when being bound by ordinary ribbons. The ribbons could bear a limited maximum load and tend to be broken for binding large goods. Moreover, the ribbons tend to be worn and eroded in use, which brings immeasurable losses.

For example, the Chinese Patent No. 2182151Y discloses a quick tie down comprised of a rope portion, a lock-up portion and a casing. The rope portion has a chain hook and a rope hook, disposed at both ends of the body. The lock-up portion has a handle, a ratchet wheel, a push claw and a check pawl. The rope portion could be moved by the lock-up portion. The goods are bound closely by using the chain hook and rope hook of the rope portion thus moved. However, ropes similar to the ribbons are still used in the quick tie down, which presents low reliability to bind the goods of large volume and mass.

Meanwhile, the conventional load binders have an integral body. As such, the body has a relatively large number of isomeric structures and thus is difficult to be processed.

### SUMMARY OF THE INVENTION

One object of the present invention is to provide a chain load binder having high reliability and a compact structure, so as to address the problems existing in the prior art.

In order to achieve the object of the invention, a chain load binder is provided, comprising a body, a handle, a tooth stop plate, a catch, a chain and a rotation shaft. The body is linked with a first hook. The handle is hinged to the body via the rotation shaft. The rotation shaft is fixedly connected with a ratchet wheel. Said tooth stop plate is movably connected with the body and the tooth stop plate is inserted onto the ratchet wheel. Said catch is movably connected with the handle and the catch is inserted onto the ratchet wheel. The central part of said chain is located within the body and wound around the rotation shaft. Both ends of the chain extend out of the body and one of the ends of the chain is fixedly connected with a second hook. A spring is provided between the tooth stop plate and the body, for making the tooth stop plate tend to be pressed against the ratchet wheel. A positioning member is further provided at the body. Both ends of said spring could act against the positioning member and the tooth stop plate respectively.

In the chain load binder of the invention, the ratchet wheel would be driven by the catch of the handle to rotate when the handle is turned to and fro. In the meantime, the ratchet wheel could only continuously rotate in one single direction by using the tooth stop plate.

The rotation of the ratchet wheel would drive the rotation shaft to rotate, which drives the chain to move. It is obvious that the second hook at the end of the chain would move as chain moves. As such, the goods would be loosened or firmly bound by the second hook thus moved.

In the chain load binder of the invention, said first hook is hinged to the body via a connection shaft. One end of the positioning member is hinged to the body via a connection shaft. A clamping mechanism is located between the other end of the positioning member and the body.

Both ends of the positioning member are fixed via the connection shaft and the clamping mechanism respectively, so that the positioning member is firmly connected with the body.

In the chain load binder of the invention, said clamping mechanism includes a raised head projecting from the positioning member and a socket on the body, and the raised head is inserted into the socket.

In the chain load binder of the invention, said clamping mechanism includes a socket on the positioning member and a raised head projecting from the body, and the raised head is inserted into the socket.

The positioning member could be fixedly connected with the body in a plug-in manner.

In the chain load binder of the invention, the said tooth stop plate has a bar-shape guide. A part of the guide passes through the positioning member. The spring is a helical spring and covered on the guide.

The spring is preliminarily located by the guide. As such, the spring would be restricted between the positioning member and the body and would not fall off by using the guide in cooperation with the positioning member.

In the chain load binder of the invention, the rotation shaft is fixedly connected with a shift element for pulling the chain. A cover plate is further provided within said body for covering the outer side of the shift element. The contact part of the chain is disposed between the cover plate and the shift element.

The contact part of the chain is covered by the cover plate, so as to effectively prevent contaminants or dust entering into the contact part.

In the chain load binder of the invention, the cover plate has a guide mechanism for guiding the movement of contact part of the chain.

The chain would not be intertwined during movement thereof by using the guide mechanism.

In the chain load binder of the invention, the guide mechanism includes a mounting hole extending through the cover plate and two chain slots in communication with the mounting hole. Said two chain slots are located on both sides of the mounting hole respectively. Said shift element is arranged at the mounting hole. The contact part of the chain passes through these two chain slots.

The mounting hole of the cover plate covers the shift element. The contact part of the chain passes through said two chain slots. The movement of the chain would be guided by the chain slots.

In the chain load binder of the invention, the said cover plate could be fixed with an auxiliary cover plate at the end. The auxiliary cover plate has several connection pores thereon. The body is provided with several joints corresponding to the connection pores, which have the same number as the connection pores and are located at the same positions as the connection pores. Each joint is fixedly connected to the corresponding connection pores.

After the joints are inserted into the connection pores, the outer ends of the joints are welded to fixedly connect the joints with the cover plate in a firm manner.

In the chain load binder of the invention, the edge of the auxiliary cover plate has a flanging projecting toward the body, and the flanging is covered on the outer side of the body. The edge of the load binder is smooth without a refractory angle by means of the flanging.

In the chain load binder of the invention, the chain slots are cross pores. As each section of the chain is interlaced at 90 degrees, the chain could move smoothly in the chain slots by means of the cross pores.

In the chain load binder of the invention, the said shift element is comprised of a cylindrical tube and several pull heads protruded on the outer side of the tube. The shift element could be covered on the rotation shaft and fixed thereto in a circumferential direction.

The tube of the shift element is fixedly connected to the rotation shaft in a circumferential direction. The pull heads on the shift element would drive the chain to move during rotation of the shift element.

In the chain load binder of the invention, the pull heads include two L-shaped pull pieces which are symmetrically disposed on the sides of the body. The outer ends of the pull pieces bend towards the central part of the body and the distance between the outer ends of these two pull pieces is slightly larger than the thickness of the link of the chain. The distance between two L-shaped pull pieces is exactly equal to the width of the chain in the vertical direction, and the width of the chain in the longitudinal direction is larger than the distance between two pull pieces. As such, the pull pieces would drive the longitudinal chain to move.

In the chain load binder of the invention, a mounting cavity matched with the cover plate is provided within the body, and the cover plate is arranged at the mounting cavity. The cover plate could be located by the mounting cavity, so that the cover plate arranged at the mounting cavity would not loosen or fall off.

In the chain load binder of the invention, the handle includes a connecting part and a stem part. The connecting part is of a U-shape. The end of the connecting part at the opening could be hinged to the body. Both sides of the connecting part are fixed with decoration boards.

The decoration boards are generally made from plastic materials. As the decoration boards have bright colors, the load binder would present an aesthetic appearance.

In the chain load binder of the invention, the connecting part of the handle has a concave connecting groove on the outer side. The decoration boards are fixed at the connecting groove and the decoration boards are level with the outer side of the handle.

Such a configuration would make the sides of the body flat.

In the chain load binder of the invention, said first hook includes a connection head, a connection rod and a hook body. The connection head is U-shaped and the terminal of the U shape of the connection head is hinged to the body. One end of the connection rod has a header of a relatively large size and the other end of the connection rod is hinged to the hook body. The connection rod could pass through the connection head and the header thereof is located within the connection head. In such a configuration, the hook body of the first hook could rotate freely, so as to be employed in various circumstances.

In the chain load binder of the invention, said second hook includes a connection head, a connection rod and a hook body. The connection head is U-shaped and the terminal of the U shape of the connection head is hinged to the end of the chain. One end of the connection rod has a header of a relatively large size and the other end of the connection rod is hinged to the hook body. The connection rod could pass through the connection head and the header thereof is located within the connection head. In such a configuration, the hook body of the second hook could rotate freely, so as to be employed in various circumstances.

Compared with the prior art, in the chain load binder of the invention, the chain at the shift element is covered by the cover plate, so that exterior contaminants or dust could not enter into the chain. Furthermore, the connecting part of the cover plate with the body is smooth, and the flanging of the cover plate could make the outer side of the load binder transit smoothly, in which case the reliability of the whole chain load binder is improved in use. The cover plate covering the contact part of the chain and the shift element as well as the decoration boards on the outer sides of the handle, provides a compact and aesthetic load binder in whole.

Meanwhile, the positioning member is separate from the body, so that both the body and the positioning member could be easily processed and connected in a simple way. Therefore, the difficulty in manufacturing the whole load binder is decreased and the load binder has a simple structure.

In addition, the first and second hooks have a simple structure and could rotate freely.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a sectional structural diagram of the chain load binder of the invention;

FIG. 2 is a top structural diagram of the chain load binder of the invention;

FIG. 3 is a stereoscopic exploded diagram of the chain load binder of the invention;

FIG. 4 is a front structural diagram of the shift element connected with the ratchet wheel in the chain load binder of the invention; and

FIG. 5 is a stereoscopic structural diagram of the shift element connected with the ratchet wheel in the chain load binder of the invention.

### DETAILED DESCRIPTION OF THE INVENTION

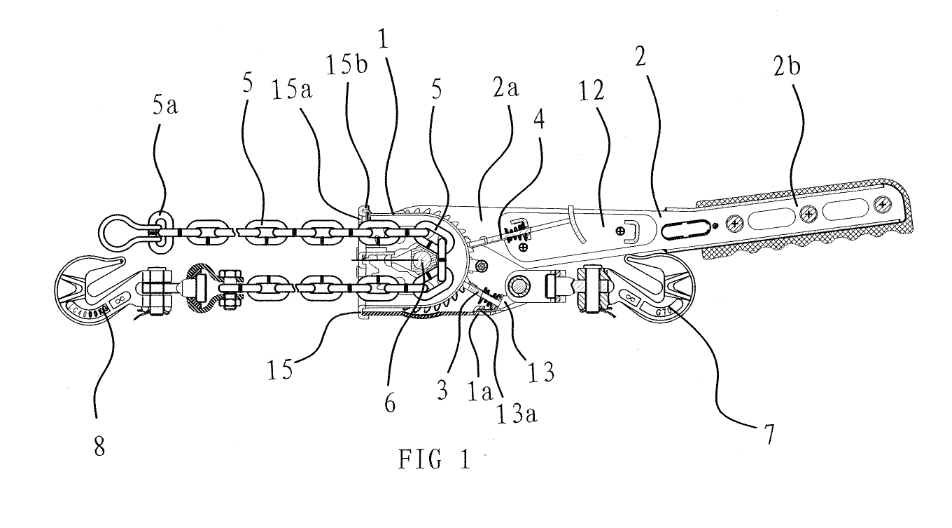

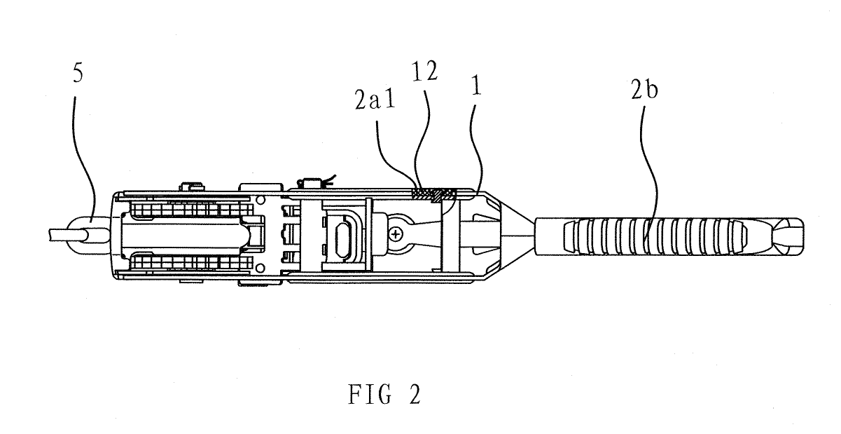

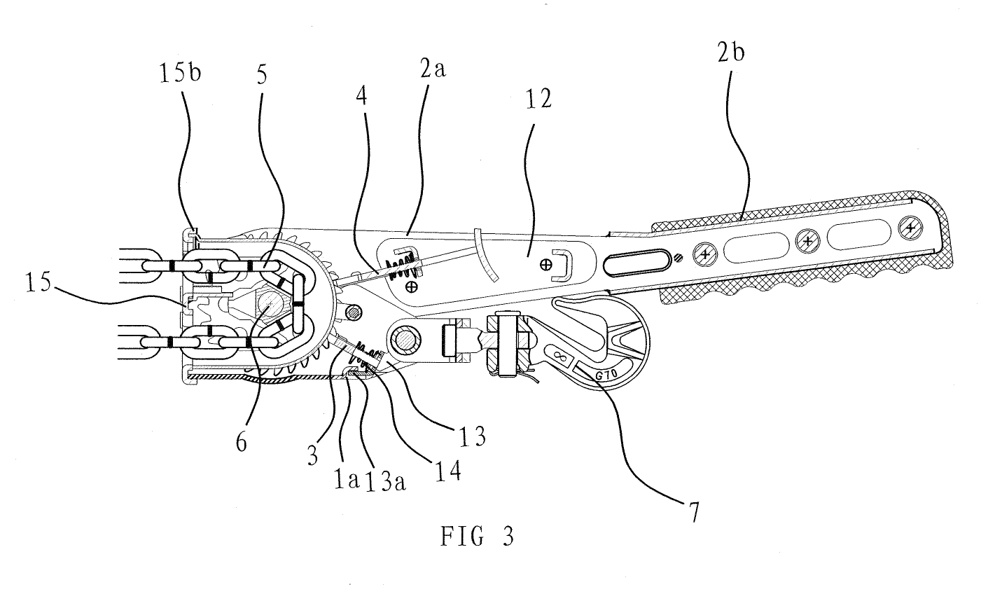

As shown in FIGS. 1, 2 and 3, the chain load binder of the invention is used for binding the goods, which includes a body 1, a handle 2, a tooth stop plate 3, a catch 4, a chain 5, a rotation shaft 6, a first hook 7 and a second hook 8.

The first hook 7 is connected to the body 1. The handle 2 is hinged to the body 1 via the rotation shaft 6. The rotation shaft 6 is fixedly connected with a ratchet wheel 9. The central part of the rotation shaft 6 is further fixedly connected with a shift element 10. The shift element 10 is comprised of a cylindrical tube 10a and several pull heads 10b protruded on the outer side of the tube 10a. The shift element 10 is covered on the rotation shaft 6 and fixed thereto in a circumferential direction.

The handle 2 includes a connecting part 2a and a stem part 2b. The connecting part 2a is of a U-shape and the end of the connecting part 2a at the opening is hinged to the body 1. Both sides of the connecting part are fixed with decoration boards 12. The connecting part 2a of the handle 2 has a concave connecting groove 21a on the outer side. The decoration boards 12 are fixed at the connecting groove 2a1 and the decoration boards 12 are level with the outer side of the handle 2.

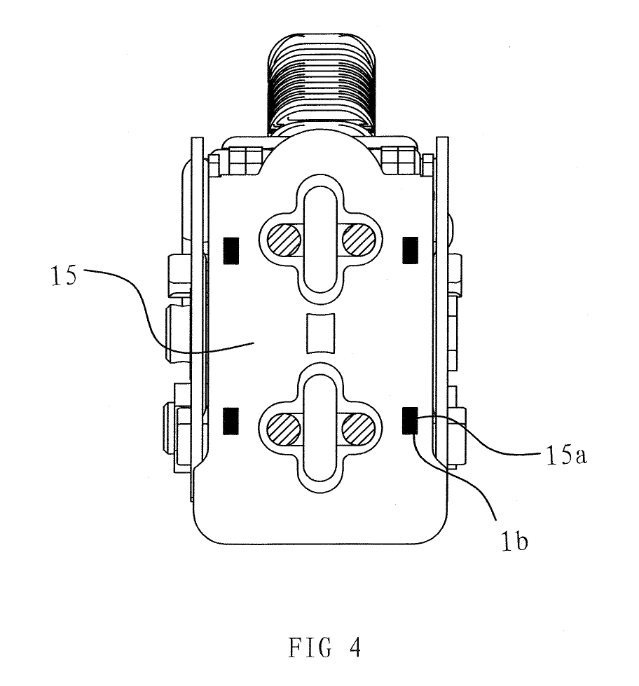

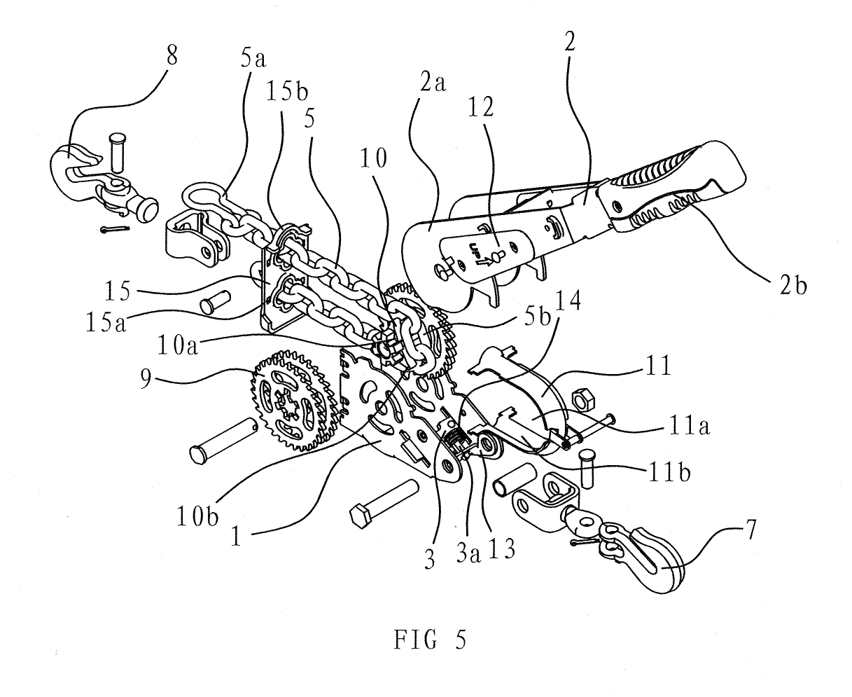

Referring to FIGS. 4 and 5, the pull head 10b includes two L-shaped pull pieces which are symmetrically disposed on the sides of the body 1. The outer ends of the pull pieces bend towards the central part of the body and the distance between the outer ends of these two pull pieces is slightly larger than the thickness of the link of the chain 5.

The tooth stop plate 3 is movably connected to the body 1. A spring is provided between the tooth stop plate 3 and the body 1. The tooth stop plate 3 is inserted onto the ratchet wheel 9 with the elastic force of the spring. The catch 4 is movably connected to the handle 2. A spring is provided between the handle 2 and the catch 4. The catch 4 is inserted onto the ratchet wheel 9 with the elastic force of the spring.

One end of the positioning member 13 is hinged to the body 1 via a connection shaft, and a clamping mechanism is located between the other end of the positioning member 13 and the body 1. The clamping mechanism includes a socket on the positioning member 13 and a raised head projecting from the body, in which the raised head is inserted into the socket. Alternatively, the clamping mechanism could have a raised head 13a projecting from the positioning member 13 and a socket 1a on the body 1, in which the raised head 13a is inserted into the socket 1a.

A spring 14 is disposed between the tooth stop plate 3 and the body 1, which makes the tooth stop plate 3 tend to be pressed against the ratchet wheel 9. Both ends of the spring 14 act against the positioning member 13 and the tooth stop plate 3 respectively. In this embodiment, the tooth stop plate 3 has a bar-shape guide 3a. A part of the guide 3a passes through the positioning member 13. The spring 14 is a helical spring and covered on the guide 3a.

One end of the chain 5 is fixed with the second hook 8. The other end of the chain 5 is a free end 5a. The chain 5 has a contact part 5b at the central portion thereof. The contact part 5b of the chain 5 is located within the body 1 and wound around the shift element 10. The second hook 8 and free end 5a of the chain 5 both extend out of the body 1.

A cover plate 11 is located within the body 1 in which a mounting cavity is provided. The cover plate 11 is arranged at the mounting cavity.

The cover plate 11 has a guide mechanism for guiding the movement of contact part 5b of the chain 5. The guide mechanism includes a mounting hole 11a extending through the cover plate 11 and two chain slots 11b in communication with the mounting hole 11a. Said two chain slots 11b are located on both sides of the mounting hole 11a respectively. The contact part 5b of the chain 5 passes through these two chain slots 11b. In this embodiment, the chain slots 11b are cross pores.

The cover plate 11 is fixed with an auxiliary cover plate 15 at the end. The auxiliary cover plate 15 has several connection pores 15a. The body 1 is provided with several joints 1b corresponding to the connection pores 15, which have the same number as the connection pores 15 and are located at the same positions as the connection pores 15a.

Each joint 1b is fixedly connected to the corresponding connection pores 15a. The edge of the auxiliary cover plate 15a has a flanging 15b projecting toward the body 1. The flanging 15b is covered on the outer side of the body 1.

The contact part 5b of the chain 5 is provided between the shift element 10 and the cover plate 11. The contact part 5b of the chain 5 is located at the guide mechanism.

When the chain load binder of the invention is in use, the handle 2 is turned to and fro, and thus the ratchet wheel 9 is driven by the catch 4 of the handle 2 to rotate. In the meantime, the ratchet wheel 9 could only continuously rotate in a single direction by using the tooth stop plate 3 when the handle 2 is turned.

The rotation shaft 6 would rotate as the ratchet wheel 9 rotates. The contact part 5b of the chain 5 is driven to move by the pull heads 10b when the shift element 10 on the rotation shaft 6 rotates. The chain 5 would smoothly move without being intertwined by using the guide mechanism of the cover plate 11, when the chain 5 is moved. Obviously, the handle 2 is turned to continuously move the chain 5 in one single direction. The chain 5 thus moved shortens the spacing between the second hook 8 and the first hook 7, so that the goods would be bound tightly through the first hook 7 and the second hook 8.

In addition, the first hook 7 includes a connection head, a connection rod and a hook body. The connection head is U-shaped and the terminal of the U shape of the connection head is hinged to the body 1. One end of the connection rod has a header of a relatively large size and the other end of the connection rod is hinged to the hook body. The connection rod passes through the connection head and the header thereof is located within the connection head. The second hook 8 includes a connection head, a connection rod and a hook body. The connection head is U-shaped and the terminal of the U shape of the connection head is hinged to the end of the chain. One end of the connection rod has a header of a relatively large size and the other end of the connection rod is hinged to the hook body. The connection rod passes through the connection head and the header thereof is located within the connection head.

The embodiments as described herein are merely illustrative, by examples, of the spirit of the present invention. Various amendments, modifications, supplementations or substitutions in similar ways, could be made to the embodiments thus described by those skilled in the art, without departing from the spirit of the invention or going beyond the scope of the invention as defined in the accompanying claims.

Although these terms are used herein, such as tooth stop plate 3, catch 4 and cover plate 11, the other similar terms could also be used. These terms are merely used to describe and explain the essence of the invention more conveniently, and any limitation to said terms is regarded as departing from the spirit of the invention.

### LIST OF REFERENCE NUMERALS

1 body
1a socket
1b joint
2 handle
2a connecting part
2a1 connecting groove
2b stern part
3 tooth stop plate
3a guide
4 catch
5 chain
5a free end
5b contact part
6 rotation shaft
7 first hook
8 second hook
9 ratchet wheel
10 shift element
10a tube
10b pull head
11 cover plate
11a mounting hole
12 decoration board
13 positioning member
13a raised head
14 spring
15 auxiliary cover plate
15a connection pore
15b flanging

What is claimed is:

1. A chain load binder, comprising a body (1), a handle (2), a tooth stop plate (3), a catch (4), a chain (5) and a rotation shaft (6), in which the body (1) could be linked with a first hook (7), the handle (2) could be hinged to the body (1) via the rotation shaft (6), the rotation shaft (6) could be fixedly connected with a ratchet wheel (9), said tooth stop plate (3) could be movably connected with the body (1) and the tooth stop plate (3) could be inserted onto the ratchet wheel (9), said catch (4) could be movably connected with the handle (2) and the catch (4) could be inserted onto the ratchet wheel (9), the central part of said chain (5) could be located within the body (1) and wound around the rotation shaft (6), both ends of the chain (5) could extend out of the body (1) and one of the ends of the chain (5) could be fixedly connected with a second hook (8), characterized in that, a spring (14) could be provided between the tooth stop plate (3) and the body (1) for making the tooth stop plate (3) tend to be pressed against the ratchet wheel (9), a positioning member (13) could be further provided at the body (1), both ends of said spring (14) could act against the positioning member (13) and the tooth stop plate (3) respectively.

2. The chain load binder as claimed in claim 1, characterized in that, said first hook (7) could be hinged to the body (1) via a connection shaft, one end of the positioning member (13) could be hinged to the body (1) via a connection shaft, and a clamping mechanism could be located between the other end of the positioning member (13) and the body (1).

3. The chain load binder as claimed in claim 2, characterized in that, said clamping mechanism includes a raised head (13a) projecting from the positioning member (13) and a socket (1a) on the body (1), and the raised head (13a) could be inserted into the socket (1a).

4. The chain load binder as claimed in claim 2, characterized in that, said clamping mechanism includes a socket (1a) on the positioning member (13) and a raised head (13a) projecting from the body (1), and the raised head (13a) could be inserted into the socket (1a).

5. The chain load binder as claimed in claim 2, characterized in that, the tooth stop plate (3) has a bar-shape guide (3a), a part of the guide (3a) could pass through the positioning member (13), and the spring (14) is a helical spring (14) and covered on the guide (3a).

6. The chain load binder as claimed in claim 1, characterized in that, the rotation shaft (6) could be fixedly connected with a shift element (10) for pulling the chain (5), a cover plate (11) could be further provided within said body (1) for covering the outer side of the shift element (10), and the contact part (5b) of the chain (5) could be disposed between the cover plate (11) and the shift element (10).

7. The chain load binder as claimed in claim 6, characterized in that, the cover plate (11) has a guide mechanism for guiding the movement of contact part (5b) of the chain (5).

8. The chain load binder as claimed in claim 7, characterized in that, the guide mechanism includes a mounting hole (11a) extending through the cover plate (11) and two chain slots (11b) in communication with the mounting hole (11a), said two chain slots (11b) are located on both sides of the mounting hole (11a) respectively, said shift element is arranged at the mounting hole (11a), and the contact part (5b) of the chain (5) passes through these two chain slots (11b).

9. The chain load binder as claimed in claim 8, characterized in that, the said cover plate (11) could be fixed with an auxiliary cover plate (15) at the end, the auxiliary cover plate (15) has several connection pores (15a) thereon, the body (1) is provided with several joints 1b corresponding to the connection pores 15, which have the same number as the connection pores 15 and are located at the same positions as the connection pores 15a, and each joint (1b) could be fixedly connected to the corresponding connection pores (15a).

10. The chain load binder as claimed in claim 8, characterized in that, the edge of the auxiliary cover plate (15a) has a flanging (15b) projecting toward the body (1), and the flanging (15b) is covered on the outer side of the body (1).

11. The chain load binder as claimed in claim 8, characterized in that, the chain slots (11b) are cross pores.

12. The chain load binder as claimed in claim 6, characterized in that, the said shift element (10) is comprised of a cylindrical tube (10a) and several pull heads protruded on the outer side of the tube (10a), and the shift element (10) could be covered on the rotation shaft (6) and fixed thereto in a circumferential direction.

13. The chain load binder as claimed in claim 12, characterized in that, the pull heads include two L-shaped pull pieces which are symmetrically disposed on the sides of the body (1), the outer ends of the pull pieces bend towards the central part of the body (1) and the distance between the outer ends of these two pull pieces is slightly larger than the thickness of the link of the chain (5).

14. The chain load binder as claimed in claim 6, characterized in that, a mounting cavity matched with the cover plate (11) is provided within the body (1), and the cover plate (11) is arranged at the mounting cavity.

15. The chain load binder as claimed in claim 1, characterized in that, the handle (2) includes a connecting part (2a) and a stem part (2b), the connecting part (2a) is of a U-shape, the end of the connecting part 2a at the opening could be hinged to the body (1), and both sides of the connecting part (2a) are fixed with decoration boards (12).

16. The chain load binder as claimed in claim 15, characterized in that, the connecting part (2a) of the handle (2) has a concave connecting groove (21a) on the outer side, the decoration boards (12) are fixed at the connecting groove (2a1) and the decoration boards (12) are level with the outer side of the handle (2).

17. The chain load binder as claimed in claim 1, characterized in that, said first hook (7) includes a connection head (1b), a connection rod and a hook body, the connection head (1b) is U-shaped and the terminal of the U shape of the connection head (1b) could be hinged to the body (1), one end of the connection rod has a header of a relatively large size and the other end of the connection rod could be hinged to the hook body, the connection rod could pass through the connection head (1b) and the header thereof could be located within the connection head (1b).

18. The chain load binder as claimed in claim 2, characterized in that, said first hook (7) includes a connection head (1b), a connection rod and a hook body, the connection head (1b) is U-shaped and the terminal of the U shape of the connection head (1b) could be hinged to the body (1), one end of the connection rod has a header of a relatively large size and the other end of the connection rod could be hinged to the hook body, the connection rod could pass through the connection head (1b) and the header thereof could be located within the connection head (1b).

19. The chain load binder as claimed in claim 1, characterized in that, said second hook (8) includes a connection head (1b), a connection rod and a hook body, the connection head (1b) is U-shaped and the terminal of the U shape of the connection head (1b) could be hinged to the end of the chain (5), one end of the connection rod has a header of a relatively large size and the other end of the connection rod could be hinged to the hook body, the connection rod could pass through the connection head (1b) and the header thereof could be located within the connection head (1b).

20. The chain load binder as claimed in claim 2, characterized in that, said second hook (8) includes a connection head (1b), a connection rod and a hook body, the connection head (1b) is U-shaped and the terminal of the U shape of the connection head (1b) could be hinged to the end of the chain (5), one end of the connection rod has a header of a relatively large size and the other end of the connection rod could be hinged to the hook body, the connection rod could pass through the connection head (1b) and the header thereof could be located within the connection head (1b).
